(19) United States
(12) Patent Application Publication
(10) Pub. No.: US 2008/0071747 A1
(43) Pub. Date: Mar. 20, 2008

(54) Target Query System and Method

(75) Inventors: James John Bohannon, Pleasanton, CA (US); Andre Calvin Burgoyne, Berkeley, CA (US); Greg Wolfe, San Francisco, CA (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: MYPOINTS.COM INC., San Francisco, CA (US)

(21) Appl. No.: 11/691,233

(22) Filed: Mar. 26, 2007

Related U.S. Application Data
(60) Provisional application No. 60/820,327, filed on Jul. 25, 2006.

(51) Int. Cl. G06F 17/30

(52) U.S. Cl. 707/3; 707/E17.14

(57) ABSTRACT

A method of performing a query of a database system includes the steps of providing a query user with query attributes in the form of question and answer combinations, constructing a logical expression from the data and the Boolean operators selected by the user, executing a query of the database system using the logical expression targeting members with attribute combinations matching the logical expression, and assigning each answer from the question and answer combination a unique identification in the database system.

### CROSS-REFERENCE TO RELATED APPLICATIONS

This application claims benefit of the following U.S. Provisional Applications: Ser. No. 60/820,327, entitled “Target Query System and Method” filed Jul. 25, 2006 (attorney docket no. 29142/42058), the disclosure of which is hereby expressly incorporated herein by reference.

### TECHNICAL FIELD

The following disclosure relates to a system and method for providing target querying of members having attributes defined within the target query.

### BACKGROUND

Users of the World Wide Web distributed computing environment may freely send and retrieve data across long distances and between remote computing devices. The Web, implemented on the Internet, presents users with documents called “web pages” that may contain information as well as “hyperlinks” which allow the users to select and connect to related web sites. The web pages may be stored on remote computing devices, or servers, as hypertext-encoded files. The servers use Hyper Text Transfer Protocol (HTTP), or other protocols to transfer the encoded files to client users. Many users may remotely access the web sites stored on network-connected computing devices from a personal computer (PC) through a browser application running on the PC.

The browser application may act as an interface between user PCs and remote computing devices and may allow the user to view or access data that may reside on any remote computing device connected to the PC through the World Wide Web and browser interface. Typically, the local user PC and the remote computing device may represent a client and a server, respectively. Further, the local user PC or client may access Web data without knowing the source of the data or its physical location and publication of Web data may be accomplished by simply assigning to data a Uniform Resource Locator (URL) that refers to the local file. To a local client, the Web may appear as a single, coherent data delivery and publishing system in which individual differences between other clients or servers may be hidden.

A system may provide web site proprietors with web site user demographics information and is generally described in U.S. application Ser. No. 09/080946, “DEMOGRAPHIC INFORMATION GATHERING AND INCENTIVE AWARD SYSTEM AND METHOD” to Bistriceanu et al., the entire disclosure of which is hereby incorporated by reference. Generally, the system may include users, web site proprietors, and an enterprise system hosting a central web site. The users may register with the central web site and may earn “points” for performing specific on- or off-line tasks in exchange for disclosing their demographic information during registration. The users may then redeem their earned points at participating proprietors for merchandise or services. Generally, the central web site manages the system by performing a number of tasks including: maintaining all user demographic information, tracking user point totals, and awarding points according to specific, proprietor-defined rules.

Information about the user, including demographic information, internet activity information or any other attribute information may be generated and stored within a profile in the system. The amount of attribute information that may be associated with a user along with a large number of users results in a large amount of data being stored within the system. The system may generate many different kinds of attribute information. The ability to conduct queries to count or identify users having particular attributes becomes more complex and expensive as more types of attributes are included within the system and as more attribute data is maintained by the system. In those situations where users having particular attributes need to be counted or identified, slow query performance and non-intuitive query commands may significantly compromise the quality, timeliness and expense of applications that utilize the query results, such as email or advertisement campaigns. This may be particularly applicable for administrative users who are unfamiliar with construction and execution of database queries.

Traditional organizations having database systems that store extremely large amounts of member information, and in particular demographic information related to members, required very complex Boolean strings to be prepared in order to perform a target query. These Boolean strings were very complex and unforgiving and required a highly trained administrative user with a strong technical background to prepare them. Thus, when a sales representative for the enterprise was in the field meeting with a client, a sales representative was forced to place a request to have the administrative user formulate the Boolean string and run a target query during negotiations with the client. This process was consistently untimely, inefficient, and cumbersome. Oftentimes, the target query would not even be able to be run while the sales representative was meeting with the client. This resulted in a negative impact on the productivity and effectiveness of the sales force for the enterprise.

### BRIEF DESCRIPTION OF THE DRAWINGS

FIG. 1 is a diagram of one example of a network and network devices;

FIG. 2 is a diagram of one example of a general computing device that may operate in accordance with the claims;

FIG. 3 is a diagram of one example of an enterprise system including two groups of servers, a web server, and a firewall as connected to the network of FIG. 1;

FIG. 4 is a flowchart describing a method of one example of using the system of FIG. 3 to award points in exchange for demographics information;

FIG. 5 is another diagram of one example of an enterprise system including a load balancer, a plurality of member server groups, and a single administrative server group;

FIG. 6 is another flowchart describing a method of one example of using the systems of FIGS. 5, 7, and 8 to award points in exchange for demographics information;

FIG. 7 is another diagram of one example of an enterprise system including twelve member server groups and a single administrative server group;

FIG. 8 is another diagram of one example of an enterprise system including a plurality of member server groups, a single administrative server groups, and several components and systems that may enhance system function;

FIG. 9 is a flowchart describing a method of one example of constructing and executing a target query;

FIG. 10 is a flowchart describing a method of one example of utilizing results from a target query to construct and execute a further target query; and

### DETAILED DESCRIPTION

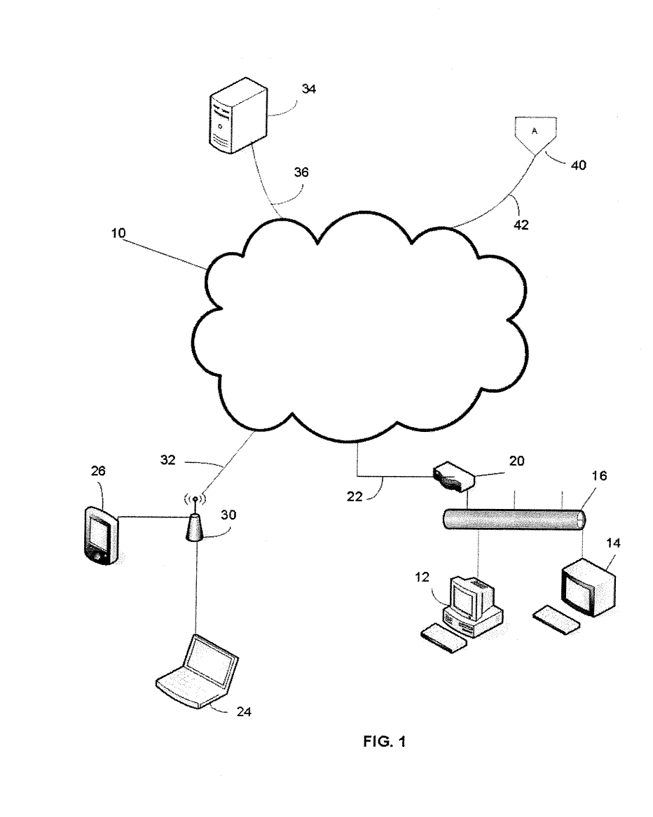

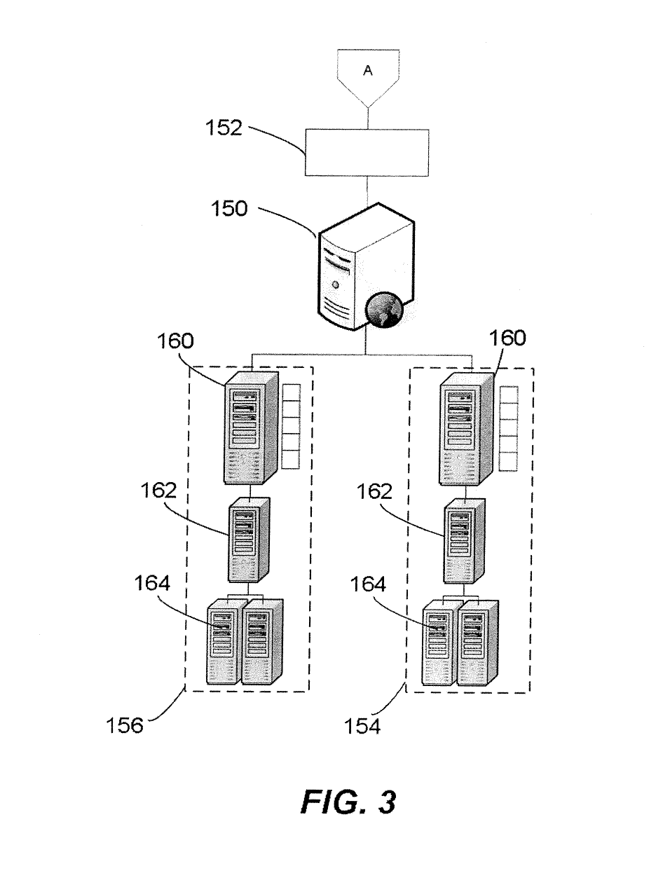

FIG. 1 illustrates an example of a network typical of the World Wide Web. A network 10 may be a virtual private network (VPN), or any other network that allows one or more computers, communication devices, databases, etc., to be communicatively connected to each other. The network 10 may be connected to a PC 12 and a computer terminal 14 via an Ethernet 16 and a router 20, and a land line 22. The network 10 may also be wirelessly connected to a laptop computer 24 and a personal data assistant 26 via a wireless communication station 30 and a wireless link 32. Similarly, a server 34 may be connected to the network 10 using a communication link 36. Also, an enterprise system 40 for awarding points to registered users in exchange for demographic information, as generally illustrated in FIGS. 3, 5, 7, and 8 may be connected to the network 10 using another communication link 42. Where the network 10 includes the Internet, data communication may take place over the network 10 via an Internet communication protocol. In operation, the client PC 12 may view or request data from any other computing device connected to the network 10. Further, the PC 12 may send data to any other computing device connected to the network 10.

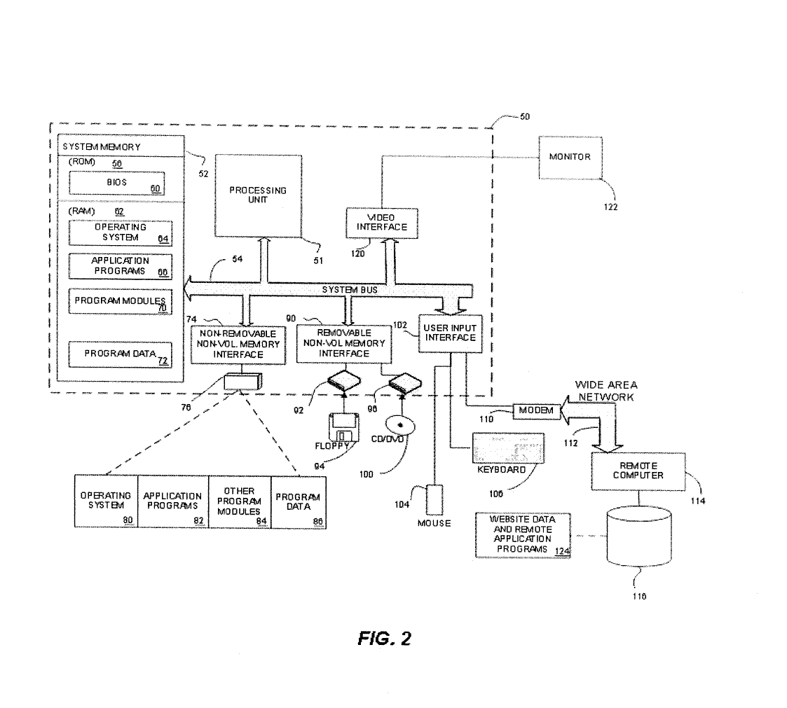

FIG. 2 illustrates a typical computing device 50 that may be connected to the network 10 of FIG. 1 and participate in a distributed computing environment such as the World Wide Web. FIG. 2 may also be an example of an appropriate computing system on which the claimed apparatus and claims may be implemented, however, FIG. 2 is only one example of a suitable computing system and is not intended to limit the scope or function of any claim. The claims are operational with many other general or special purpose computing devices such as PCs 12, server computers 34, portable computing devices such as a laptop 24, consumer electronics 26, mainframe computers, or distributed computing environments that include any of the above or similar systems or devices.

With reference to FIG. 2, a system for implementing the steps of the claimed apparatus may include several general computing devices in the form of a computer 50. The computer 50 may include a processing unit, 51, a system memory, 52, and a system bus 54 that couples various system components including the system memory 52 to the processing unit 51. The system bus 54 may include an Industry Standard Architecture (ISA) bus, a Micro Channel Architecture (MCA) bus, Enhanced ISA (EISA) bus, Video Electronics Standards Association (VESA) local bus, a Peripheral Component Interconnect (PCI) bus or a Mezzanine bus, and the Peripheral Component Interconnect Express (PCI-E) bus.

The computer 50 may include an assortment of computer-readable media. Computer-readable media may be any media that may be accessed by the computer 50. By way of example, and not limitation, the media may include both volatile and nonvolatile media, removable and non-removable media. Media may also include computer storage media and communication media. Computer storage media may include volatile and nonvolatile, removable and non-removable media that stores information such as computer-readable instructions, program modules, data structures, or other data. Computer-storage media may include RAM, ROM, EEPROM, or other memory technology, optical storage disks, magnetic storage devices, and any other medium which may be used to store computer-accessible information. Communication media may be computer-readable instructions, data structures, program modules, or other data in a modulated data signal or other transport mechanism. Communication media may include wired media such as a wired network or direct-wired connection, and wireless media such as RF, infrared, and other wireless media.

The system memory 52 may include storage media in the form of volatile and/or non-volatile memory such as ROM 56 and RAM 62. A basic input/output system 60 (BIOS), containing algorithms to transfer information between components within the computer 50, may be stored in ROM 56. Data or program modules that are immediately accessible or are presently in use by the processing unit 51 may be stored in RAM 62. Data normally stored in RAM while the computer 50 is in operation may include an operating system 64, application programs 66, program modules 70, and program data 72.

The computer 50 may also include other storage media such as a hard disk drive 76 that may read from or write to non-removable, non-volatile magnetic media, a magnetic disk drive 251 that reads from or writes to a removable, non-volatile magnetic disk 94, and an optical disk drive 96 that reads from or writes to a removable, nonvolatile optical disk 100. Other storage media that may be used includes magnetic tape cassettes, flash memory cards, digital versatile disks, digital video tape, solid state RAM, and solid state ROM. The hard disk drive 76 may be connected to the system bus 54 through a non-removable memory interface such as interface 74. A magnetic disk drive 92 and optical disk drive 96 may be connected to the system bus 54 by a removable memory interface, such as interface 90.

The disk drives 92, 96 transfer computer-readable instructions, data structures, program modules, and other data for the computer 50 to different storage media 94, 100 for storage. A hard disk drive 76 may store an operating system 64, application programs 66, other program modules 70, and program data 72. These components may be the same or different from operating system 64, application programs 66, other program modules 70 and program data 72. The components associated with the hard disk drive 76 may be different copies than those associated with RAM 62.

The user may interact with the computer 50 through input devices such as a keyboard 106 or a pointing device 104 (i.e., a mouse). A user input interface 102 may be coupled to the system bus 54 to allow the input devices to communicate with the processing unit 51. A display device such as a monitor 122 may also be connected to the system bus 54 via a video interface 120.

The computer 50 may operate in a networked environment using logical connections to one or more remote computers 114. The remote computer 114 may be a PC 12, a server 34, a router 20, or other common network node as illustrated in FIG. 1. The remote computer 114 typically includes many or all of the previously-described elements regarding the computer 50, even though only a memory storage device 116 is illustrated in FIG. 2. Logical connections between the computer 50 and one or more remote computers 114 may include a wide area network (WAN) 112. A typical WAN is the Internet. When used in a WAN, the computer 50 may include a modem 110 or other means for establishing communications over the WAN. The modem 110 may be connected to the system bus 54 via the user input interface 102, or other mechanism. In a networked environment, program modules depicted relative to the computer 50, may be stored in the remote memory storage device 116. By way of example, and not limitation, FIG. 2 illustrates website data and remote application programs 124 as residing on the memory device 116. As may be appreciated, other means of establishing a communications link between the computer 50 and the remote computer 1140 may be used.

As previously described, the system may award users with redeemable points for many reasons, such as, in exchange for collecting and releasing user demographic information to proprietors or clients and for users taking any action associated with a “campaign,” or set of rules negotiated by the proprietor. As used herein, a user or member may be any person, apparatus, method, or the like that employs a computing device 200 to access the system to earn redeemable points by completing proprietor-defined tasks in exchange for submitting and releasing demographic information to the system.

Further, as used herein, “demographic information” may be broadly construed and may include any kind of member descriptive data, any activity associated with a member, or any transaction associated with a member. Demographic information may be gathered by the system upon user registration in the form of a questionnaire designed to solicit various demographics data of interest to the proprietors. The questionnaire may be in the form of a website page or any other format able to collect demographics information from the user. Users may register in a variety of ways including direct registration at the central web site hosted by the enterprise system, registration through web site proprietors, a web based ”refer-a-friend” program, third-party direct mailing, or other partner relationships. A user may need only to register with the system once. However, the user may earn additional points by completing future, supplementary questionnaires. Typical examples of information gathered by the questionnaires may be the user's age, income, occupation, etc. Further, the system may award a user for specific actions such as viewing web-based content, purchasing goods or services through a system-sponsored website, a proprietor's website, a proprietor's brick-and-mortar facility, or any other action associated with the system. The demographics information, to include but not limited to information gathered by questionnaire or records of any user action taken at the suggestion of or related to the system and a proprietor campaign, may be aggregated into a unique user profile. Once the user creates a profile, all future user activity within the system may be uniquely associated with the user's profile. A user may participate in the system by using a network 10 and a PC 12.

Further, as used herein, a proprietor or client may be any entity, corporation, web site manager, business owner, or the like that coordinates with the system by submitting a set of proprietor-defined award rules or tasks that a user may complete to earn redeemable points. The proprietor may also purchase user demographic information from the system and provide product price reductions or other benefits to users in exchange for user demographic information, or may complete any combination of these functions. This set of proprietor-defined rules or tasks may be called a “campaign.” Each campaign may further include a template for e-mails to he sent by the system to targeted users. A proprietor may compensate the system for receiving the users' demographic information in a number of ways including: monthly sponsorship fees for the system displaying their offers on the central web site; per action fees when users follow specific actions provided to the system; per click fees for users clicking on hyperlinks provided in targeted e-mails advertising proprietor services or products and directing the user to a proprietor Web page; per e-mail delivery fees; advertisement placement within “newsletter” e-mails that the system may send to all system-registered users; and other fee combinations including indirect, agency relationships between proprietors and the system. Also, the system may compensate a proprietor for soliciting new memberships. The system may further automate billing clients based on a set billing rules within each campaign. The billing rules may be associated with award rules and user activity. For example, within a particular campaign, an award campaign rule may award a member two hundred points for making a single purchase with a proprietor. The campaign may also include a billing rule indicating that the proprietor may be billed at five percent one all purchases made by the member, even though only the first transaction awarded points. Also, a proprietor may customize its campaign to award a user points in a variety of methods. For example, a proprietor may choose the number of points to be awarded to users, may specify activities or questions that must be completed by the user before points are awarded, or may limit the frequency at which users can be awarded points for visiting the site. A proprietor may also dictate different user questionnaires during the registration process or may provide an additional questionnaire as a user task to be completed by the user to earn additional points.

Also, as used herein, the system may refer generally to the method or apparatus that coordinates user and proprietor functions by collecting user demographic information, awarding redeemable points to the users, tracking points for the users or proprietors, aggregating statistical information concerning user activity and the demographic information, maintaining the proper function of all user and proprietor activity, providing statistical and demographic information to the proprietors, sending targeted e-mail to the users, and executing any other management or coordination functions. The targeted e-mails may contain hyperlinks that direct users to proprietor offers that may award or redeem points to a specific user account. The system may be a collection of devices, typically general purpose computing devices 50, servers, 34, and data stores connected to and in communication with a user PC 12 through a network 10.

A system for collecting demographics information in exchange for awarding redeemable points may include a variety of structures and components as generally described in relation to FIGS. 3, 5, 7, and 8. Therefore, the system configurations described in relation to FIGS. 3, 5, 7, and 8 may include any combination of elements described in relation to each figure.

With reference to FIG. 3, the system 150 may include an architecture that is N-tier with a web server 151 in communication with a system firewall 152 through which a user may access a website hosted on the web server 151 by the system 150. The system firewall 152 may provide a secure, high-speed connection to a computer network such as the Internet as illustrated in FIG. 1. The web server 151 may face the users and communicate with a number of server groups or “silos” such as silo 154 and silo 156. A silo may be a conceptual collection of servers that work together through an application interface. Each silo may include, for example, an application server 160 that may execute a system application program 161.

With reference to FIG. 2 and FIG. 3, a system application program 161 running on the application server 160 may be an application program 66 or a remote application program 124 and may perform any coordination, transformation, or update process on the data entering or exiting the master data server 162. Further, a system application program 161 may execute on any general computing device 50 or any system 150 component. A system application program 161 running on the application server 160 may include, for example, any combination of an e-mail engine, a query engine, a validation engine, a crypto engine, an award engine, or a transaction engine.

Returning to FIG. 3, the application server 160 may communicate between the web server 151 and a master data server 162 to pass data from the web server 151 or to pass data generated by the system application programs 161 to the master data server 162 or any other system 150 element. The master data server 162 may include a portion of the total system 150 data, consisting of, for example, user demographic data, campaign data, and any other data used by the system 150. In turn, the master data server 162 may communicate with replication data servers 164. The replication data servers 164 may include a duplicate copy of the user profile data assigned to the silos 154, 156.

The system capacity is expanded simply by adding more silos 154, 156. The silos 154, 156 may also provide specialized functions within the system 300. For example, the silo 156 may be an administrative silo 156. The administrative silo 156 may be used by the system 150 to manage system information, campaign information, or any other information not related to the user profiles. The administrative silo 156 may also include a lookup table that may direct any data queries to the correct member silo 154. The administrative silo 156 may combine several different functions together, or it may be split apart into separate silos. For example, one administrative silo may contain campaign information while a separate administrative silo may contain a lookup table to direct any data queries to the correct member silo 154. Alternatively, there could be a third administrative silo which manages, for example, inventory information for redemptions. Thus, the administrative functions need not be confined to a single administrative silo. It should be noted that separating some functions into multiple administrative silos may increase the scalability of the system as a whole.

The member silo may hold the system 150 member information. The member information may include, for example, the user profile, demographics data, transactions, or point balances. As illustrated in FIG. 3, a system comprising one member silo 154 may hold approximately 100% of the total system 150 user information. Upon registration, a member's information may be stored in the member silo 154. The silo containing the member's registration data may be called the member's “home silo.” Each member's information may be kept in the member's “home silo,” and may remain in the home silo unless more member silos are added to the system 150.

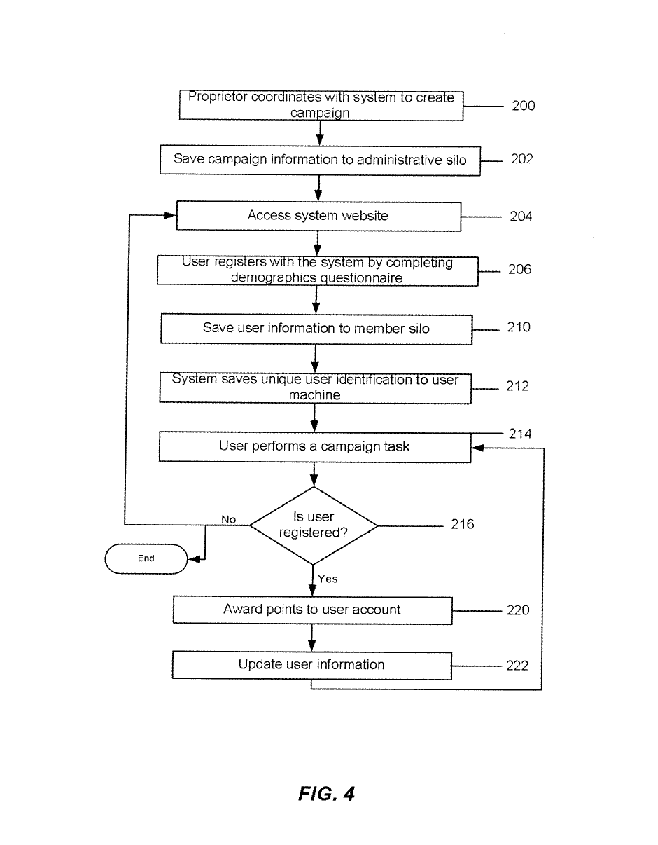

With reference to FIG. 1, FIG. 3, and FIG. 4, a method employing the enterprise system 300 may provide a user with a number of redeemable points for the user's submission of demographic information and participation in a variety of ecommerce related activities, including making purchases from proprietors. The user may then redeem their points for products and services from the participating proprietors such as retailers, theaters, restaurants, airlines, and hotels, among others. At step 200, a proprietor may coordinate with the system 150 to create a campaign For example, the proprietor may request information from the system 150 to target a specific demographic variable such as age, gender, income, or job. At step 202, the campaign information may be distributed to the silos 154, 156 and distributed across all system master data servers 162. At step 204, a user may login to the system 150 using a general purpose personal computer (PC) 12 connected to a network 10 such as the Internet.

As previously described, at step 206, the user may register with the system 150 by accessing a web site hosted by the system 150 at the web server 151. During registration, the user may complete a demographics questionnaire in the form of a web site or other electronic document. The demographics questionnaire may include various questions concerning the user's background including, for example, the user's age, sex, zip code, job title, or marital status. The system, 150 may collect the demographics data in a variety of formats including free form text, drop down menu selections, or Boolean values.

At step 210, the user's registration information and demographic data may be saved to a member silo 154. At step 212, the system may save a unique user identification to the users PC 105. The unique user identification may be used by the system to associate proprietor campaign tasks and user actions to award points. The unique user identification may be encrypted in the form of a “cookie” associated with the user's browser that may be used to associate the user with the registration information stored on the administrative silo 156. Further, the system may assign a 64-bit random number to each user upon registration. Because of the extremely low statistical probability of assigning identical 64-bit random numbers to more than one member upon registration, the system 150 need not verify that the random number has been previously assigned. The random user identification assignment may allow the system 150 to more easily select random user demographic information for analysis. Particularly, because the numbers are randomly assigned, any set of records associated with a sequential selection of the random user identifier may be very unlikely to overlap with any other set chosen by the random number. Further, because the random numbers are only used for choosing a random set of members for statistical analysis, a small number of users with identical random numbers will not distort the results. Therefore, because the probability of the system 150 assigning identical 64-bit random numbers is very small, and a few identical numbers will have very little effect on statistical analysis, it may be unnecessary to ensure that a random number has not been previously assigned.

At step 214, the user may perform any of the tasks or actions specified in the proprietor's campaign stored on the administrative silo 156 to earn redeemable points. For example, a campaign task may be visiting the proprietor's web site or responding to a system 150 generated e-mail.

Each proprietor web site may include a visual cue that the web site is a member of the points-awarding program. The visual cue may include a hyperlink pointing to the web server 151. The hyperlink may include a code called an “cell identification” that may optionally be encrypted and may associate the user's selection of the hyperlink with a campaign task saved on the administrative silo 156. Further, the cell identification may provide information associated with all campaign rules. A user may also receive and select hyperlinks associated with a proprietor's campaign in an e-mail message generated by an e-mail engine running as a system application program 161 on the replication server 164.

The e-mail engine could alternatively be run on the application server 160. However, to increase efficiency, the e-mail engine is run on one or more of the replication servers 164 on each member silo 154. In this way, the e-mail engine communicates locally with the database, avoiding network traffic and also avoiding additional load on the application server 160 which is servicing member requests in real-time. This is possible because the e-mail engine is able to work with a replicated copy of the member information. This provides for a great deal of scalability, as additional replication servers 164 could be added. For example, the replication servers 164 could be increased from two to four so that more than one e-mail engine is running for a given member silo 154.

At step 214, the administrative silo 156 and the application server 160 may validate the user's registration with the award program by comparing the user's cookie file with the registration information stored on the administrative silo 156. The validation process may be performed by a validation engine running as a system application program 161 on the application server 160. If the information received by the application server 315 is encrypted, a crypto engine running as a system application program 161 on the application server 160 may decrypt the information. If the user is not registered, at step 216, the process may terminate or, alternatively, the user may be directed to the system registration web site at step 204. If the user is validly registered, the system 150 may proceed to step 217.

At step 217, the validation engine may determine if the user has previously completed the campaign task associated with step 214. As described above, awarding points may be conditional and defined by the proprietor campaign rules. The campaign tasks and rules may be defined by the proprietor and stored on the administrative silo 156 or distributed across all system 150 silos 154, 156. The tasks and rules may be indexed on the administrative silo 156 by the cell identification. Using the cell identification, the validation engine may determine that a particular cell identification has been previously used, also indicating that the user has previously performed the task and that the user is ineligible for additional points. If the user has previously performed the task, the system 150 may terminate or direct the user to perform a different task. If the user has not yet performed the task, the system may proceed to step 220.

At step 220, if the user is validly registered and has not yet performed the present campaign task, a transaction engine running as a system application program 161 on the application server 160 may award a predetermined number of points to the user's account saved on the member's home silo 154 by associating the campaign task, cell identification, and point quantity with the unique user identification.

At step 222, the transaction engine running as a system application program 161 on the application server 160 may update transaction information associated with the user at the member's home silo 154. Transaction information may later be used by the system 150 to develop demographic information and statistics associated with the user actions to provide to the proprietors. Therefore, upon visiting the proprietor site, the system 150 may automatically award points to the registered user without requiring the user to leave the proprietor web site. The system 150 may be distributed across multiple participating web sites and may operate without the knowledge of the user. Optionally, the proprietor's web sites may determine whether a web site visitor is one of the participating users.

The system 150 may also provide hyperlinks to redemption sites at which the users may convert earned points into products or services. The hyerlinks may be embedded in e-mails generated by the e-mail engine system application program 161. Further, the hyperlinks may point to redemption web sites hosted by the system 150 or on hosts at any other proprietor-designated site. The system 150 may automatically accept redemption orders, place purchase orders with vendors for the requested product or service, and may direct the proprietor or vendor to deliver the redeemed products to the user. The points may be automatically deducted from the user's account.

The system 150 may also develop demographic information and statistics to provide for the proprietors. The system 150 may associate the user demographic information with the users actions associated with the proprietor or any other web site. For example, the percentage of the males visiting a particular web site or web pages may be calculated by looking at each participating visitor in the member silo 154, checking a field in the member silo 154 for each member's sex, and tabulating the results.

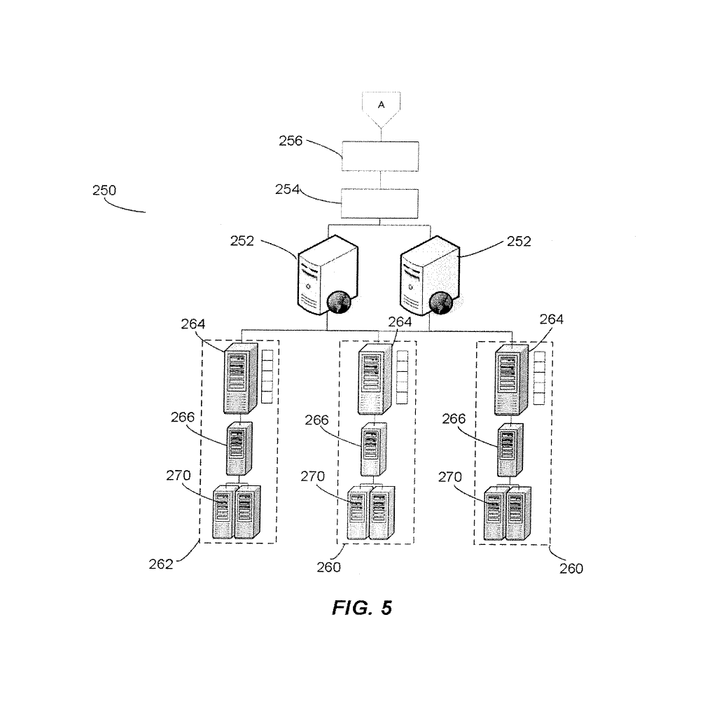

With reference to FIG. 5, the system 250 may include a distributed architecture that is N-tier with web servers 252 that may communicate with a load balancer element 254, wherein the load balancer element 254 communicates with a system firewall 256 and the web servers 252. The load balancer 254 may randomly distribute all data entering the system 250 through the firewall 256 across the web servers 252. The web servers 252 may then determine a silo 260, 262 to send the data. Thus, upon the receipt of data, the load balancer 254 may select a random web server 252, and the randomly-selected web server 252 may forward the data to a specific silo 260, 262, or to a randomly-selected silo 260, 262. The randomly-selected silo 260, 262 may then determine whether to process the data or forward the data to another silo 260, 262. The load balancer's 254 random distribution of data may reduce data latency through the system 250. The load balancer element 254 may include a method executing on a general purpose computer 50 or on any device associated with the system 250 as either software or hardware.

The system firewall 256 may provide a secure, high-speed connection to a computer network such as the Internet as illustrated in FIGS. 1. The web server 252 may face the users and communicate with a number of silos 260, 262. A silo may be a conceptual collection of servers that work together through an application interface. Each silo may include, for example, an application server 264 that may execute a system application program 265. A system application program 265 running on the application server 264 may perform any coordination, transformation, or update process on the data entering or exiting the master data server 266. Further, a system application program 265 may execute on any general computing device 50 in communication with the master data server 266. A system application program 161 running on the application server 160 may include, for example, any combination of an e-mail engine, a query engine, a validation engine, a crypto engine, an award engine, or a transaction engine. Each silo may include an application server 264, wherein the application server 264 may communicate between the web server 252 and a master data server 266, and the master data server 266 may communicate with replication data servers 270. The replication data servers 270 may include a duplicate copy of the user profile data assigned to a silo 260, 262.

The silos 260, 262 may provide simple system expandability by providing more silos 260, 262 to the system. The silos 260, 262 may also provide specialized functions within the system 250. For example, the silos 260, 262 may include an administrative silo 262 and member silos 260. The administrative silo 262 may be used by the system 250 to manage system information, campaign information, or any other information that may not relate to the user profiles. The administrative silo 262 may also include a lookup table that may direct any data queries to the correct member silo 260. The member silos 260 may hold an equal or approximately equal fraction of the total amount of user information contained in the system 250 as determined by the load balancer 254. As illustrated in FIG. 5, a system comprising two member silos may each hold approximately 50% of the total system 250 user information. Upon registration, a user's information may be stored on a single, randomly selected member silo 260. The silo containing the user's registration data may be called the user's “home silo.” Each user's information may be kept in the user's “home silo,” and may remain in the home silo unless the member silos 260 are rebalanced. By randomly assigning profiles to the silos, the system load may be balanced and the number of user profiles saved to a single member silo 260 may be no more than any other individual silo 260.

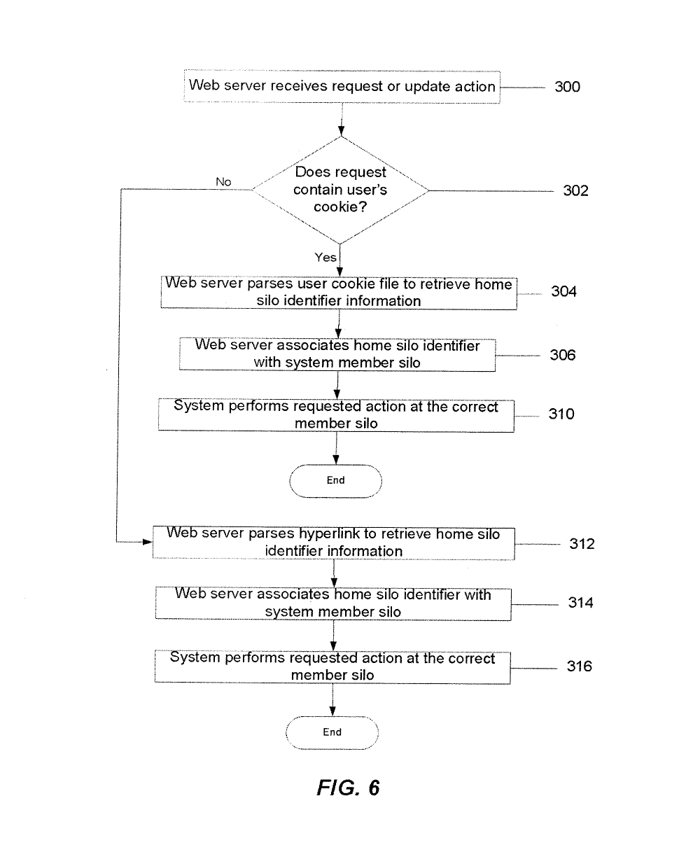

With reference to FIG. 5 and FIG. 6, and as previously described in relation to FIG. 4, the system 250 may need to periodically retrieve or update member silo 260 data to the user's home silo. To correctly identify the user's home silo upon a retrieve or update action, the user's home silo identifier may be persistently stored in several different forms. Particularly, the home silo identifier may be part of a hyperlink in a bulk e-mail sent from the system 250 to the user. Further, the home silo identifier may be part of a URL stored at the user's computer, or may be part of a cookie file. The persistent storage of the user's home silo identifier on the user's computer may also reduce any system 250 overhead associated with finding the user's information. However, once the user is at the system 250, the home silo identifier is not needed to view any successive pages during a single session; the system only requires the home silo identifier upon the first action a user takes at the system 250 during the session. Therefore, the system 250 may acquire user's unique identification number and home silo identifier through encrypted information embedded in a hyperlink included in an e-mail or from any other source. By using the encrypted information, the user may not need to login to the system 250 to complete a transaction. A user may only need to explicitly login to the system 250 when the user visits the central website without going through a hyperlink containing the encrypted identification information and the user's browser does not contain an identifying cookie, or, when the user may perform a “sensitive” action associated with a user's private information or a transaction that may decrease the user's accumulated points.

The system 250 may identify not only the user's home silo but also cached user information through the use of an “application server session.” During an application server 264 session, the system 250 may automatically store a cookie on the user's browser. The cookie may then be used to locate any cached information (including the user's home silo identifier) on successive page views. During an application server session, the cookie may be referred to as a “session cookie.” Thus, while the user is actively at the system 250 and keeping his session with the system 250 open (i.e. does not end the session by closing the browser, deleting all browser cookies, or otherwise ending his session), the system 250 may not need to actively find the user's home silo identification. The system 250 may automatically forward requests to a user's home silo based on the user's application server 264 session. The system may automatically forward the requests using an Apache™ web server 252 with ModJK extensions to a Jetty™ Java™ servlet engine application server 264.

At step 290, the system 250 may receive a user login request, registration request, or update action. If, at step 292, the system 250 receives a new registration, the load balancer 254 may forward the data to a random web server 252 and the web server 252 may assign the registration information a random home silo identifier. By randomly assigning all registrants a home silo identifier, each member silo may contain an approximately equal amount of member information. Further, the data need not retain its home silo identification for its lifetime and may be distributed to other silos 260, 262 as needed for redistribution because no particular data characteristic may tie the data to a silo 260, 262.

After storing the new member information, the system 250 may proceed to step 314. The user request or update action may come from a hyperlink embedded in a targeted e-mail generated by the e-mail engine executing as a system application program 265 on the application server 264. The hyperlink may include the user's home silo identifier information, or alternatively, the action may originate from the user's browser and include the user's cookie file.

If, at step 292, the system 250 receives a non-registration request, the system may, at step 302, determine if the request contains the user's cookie file. At step 304, if the request contains the user's cookie file, the web server 252 may parse the user's cookie file to retrieve the user's home silo identifier information. At step 306, the web server 252 may associate the home silo identifier with a particular system 250 member silo 260. At step 310, the system 250 may perform the requested action at the user's home silo 260. Therefore, the system 250 may perform the action with the user's home silo 260 without performing a lookup or redirect action when the action includes the user's cookie file.

If, at step 302, the request does not contain the user's cookie file, the request likely originated from a system-generated hyperlink that was targeted to a particular user, or the user's browser may not contain the cookie file that correctly associates the user with the user's home silo. The hyperlink therefore may contain the user's home silo identifier 260. At step 312, the web server 252 may then parse the hyperlink to retrieve the user's home silo identifier information. At step 314, the web server may associate the home silo identifier with the correct member silo 260. Therefore, the system 250 may perform the action with the user's home silo 260 without performing a lookup or redirect action when the action originates from a hyperlink containing the user's home silo identifier.

Further, the user's cookie file may contain an inaccurate home silo identifier due to data redistribution or any other reason that may result in the user's data being moved to a location other than a location indicated by the cookie file. If the inaccurate information leads the action to an incorrect silo, the receiving member silo 260 may treat the action as if no browser cookie existed and perform a lookup action to re-direct the data to the correct silo and save a new, accurate, cookie file to the user's browser. Therefore, the system 250 may perform the action with the user's home silo 260 by performing a lookup or redirect action when the action includes an inaccurate cookie file.

Further, if the user's cookie is not set, the system may perform a lookup action by accessing the lookup table residing on the administrative silo 262. Also, if the member's cookie is not set or not present, the load balancer 254 may direct the user to a random member silo 260. A system application program 265 running on the application server 264 may query the master data server 266 or the replication data servers 270 to determine if the action relates to member information stored at that silo 260. If the member data is not stored on the silo 260, the application server 264 may broadcast a request to all silos 260, 262 to find the user's home silo. Once the user's home silo 260 is found, the system 250 generates a re-direct message to the user's browser to re-establish a connection to the system 250 through the web server 252 at the proper home silo 260. The user's browser may then re-establish a connection to the system 250 with a connection message containing the correct home silo 260 identifier. Once the web server 252 receives the re-connect request, user is directed to the proper home silo 260, and the transaction may continue. At step 316, the system 250 may perform the requested action at the correct member silo 260.

As may be appreciated by one of ordinary skill in the art, the system's silo architecture is scalable and inexpensive. Further, the system is robust in that a single silo's malfunction will not degrade the function of the entire system.

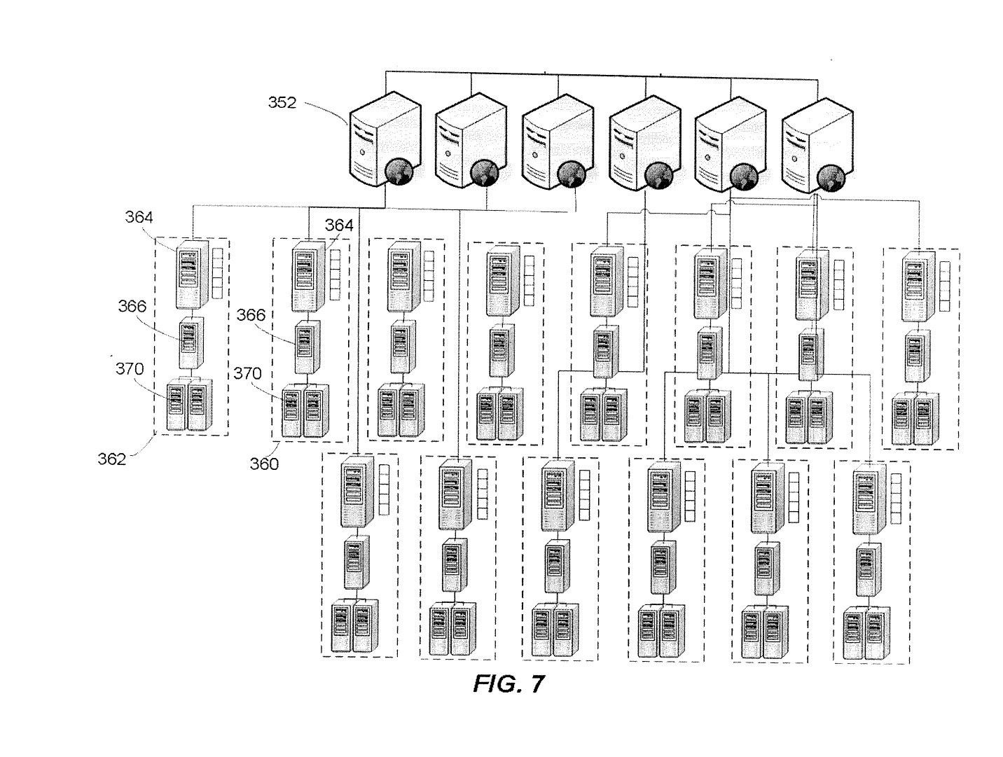

With reference to FIG. 7, the system 350 may also include a distributed architecture that is N-tier with six web servers 352 that may communicate with two load balancer elements 354, wherein the load balancer elements 354 communicate with a system firewall 356 and the web servers 352. The load balancer 354 may randomly distribute all data entering the system 350 through the firewall 356 across the web servers 352. The load balancer's 354 random distribution of data may reduce data latency through the system 350. The load balancer element 354 may include a method executing on a general purpose computer 50 or on any device associated with the system 350 as either software or hardware. The system firewall 356 may provide a secure, high-speed connection to a computer network such as the Internet as illustrated in FIG. 1. The web servers 352 may face the users and communicate with a number of silos 360, 362. A silo may be a conceptual collection of servers that work together through an application interface. Each silo may include an application server 364 executing a system application program 365, wherein the application server 364 may communicate between the web servers 352 and a master data server 366, and the master data server 366 may communicate with replication data servers 370. The master data server 366 and the replication data servers 370 may contain the member profile data to include demographic information, member transaction information, and all member-related data. Member transaction information may include records of every activity in which the member participates including registration information, purchase and activity tracking information, and point-earning information. A system application program 365 running on the application server 364 may perform any coordination, transformation, or update process on the data entering or exiting the master data server 366. Further, a system application program 365 may execute on any general computing device 50 in communication with the master data server 366. A system application program 365 running on the application server 364 may include, for example, any combination of an e-mail engine, a query engine, a validation engine, a crypto engine, an award engine, or a transaction engine. The replication data servers 370 may include a duplicate copy of the user profile data assigned to a silo 360, 362.

The silos 360, 362 may provide simple system expandability by providing more silos 360, 362 to the system. As illustrated in FIG. 7, the system may be expanded to 13 silos 360, 362. The silos 360, 362 may also provide specialized functions within the system 350. For example, the silos 360, 362 may include an administrative silo 362 and twelve member silos 360. The administrative silo 362 may be used by the system 350 to manage system information, campaign information, or any other information that may not relate to the user profiles. The administrative silo 362 may also include a lookup table that may direct any data queries to the correct member silo 360. The member silos 360 may hold an equal or approximately equal fraction of the total amount of user information contained in the system 350 as determined by the load balancer 354 random assignment. As illustrated in FIG. 7, a system comprising twelve member silos may each hold approximately 8% of the total system 350 user information. Upon registration, a user's information may be randomly stored in one member silo 360. The silo containing the user's registration data may be called the user's “home silo.” Each user's information may be kept in the user's “home silo,” and may remain in the home silo unless the member silos 360 may be rebalanced. By randomly assigning profiles to the silos, the system load may be balanced and the number of user profiles saved to a single member silo 360 may be no more than any individual silo 360.

Further, the member silos 360 may have differing storage capacities. The random distribution of data stored on each member silo 360 may then be based on the percentage of system capacity represented by a particular member silo 360 by weighting the preference of the web server 352 to select a home silo 260 upon registration Thus, a silo 360 having twice the capacity as another silo 360 may be given twice the weighting during random selection. Each user's information may be kept in the user's “home silo,” and may remain in the home silo unless the member silos 360 may be rebalanced. By randomly assigning profiles to the silos, the system load may be balanced and the number of user profiles saved to a single member silo 360 may be no more than any individual silo 360. Also, each silo 360 may poll the system 350 to determine its percentage of system capacity. Instead of random home silo selection, a closed-loop selection mechanism may, for new registrations or anonymous requests, prefer the silo 360 with the least-utilized capacity. Capacity may be measured by any suitable function and may take into account, for example, the amount of disk space available, the system processing load, the I/O capacity, the number of members, or other factors.

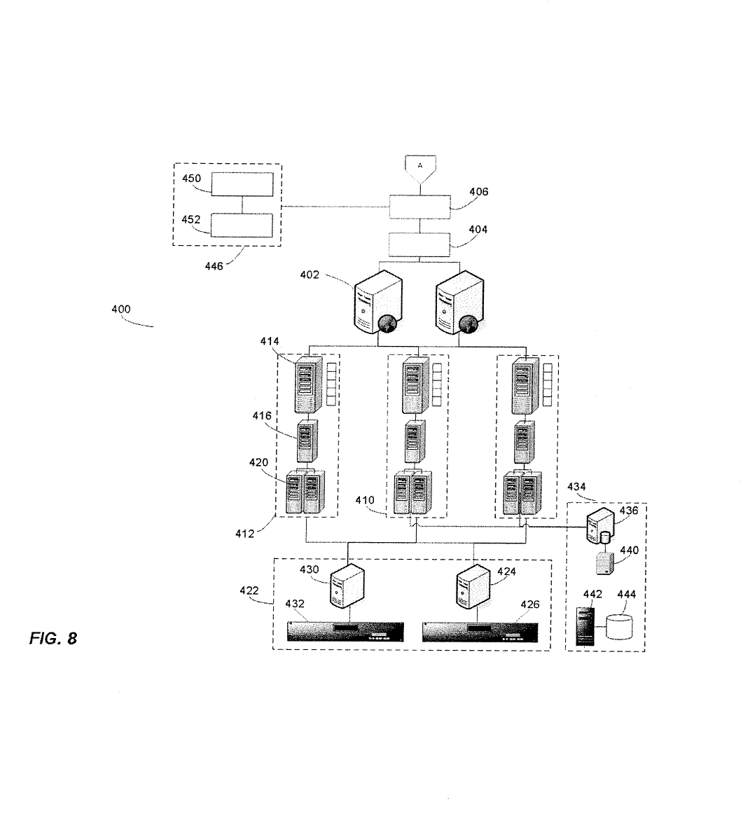

With reference to FIG. 8, the system 400 may also include several components that may complement the awarding of points as previously described. Further, the components may also be added to any of the systems 150, 250, 350 as previously described. As described above, the system 400 may include a distributed architecture that is N-tier with web servers 402 that may communicate with a load balancer element 404, wherein the load balancer element 404 communicates with a system firewall 406 and the web servers 402. The load balancer 404 may randomly distribute all data entering the system 400 through the firewall 406 across the web servers 402. The load balancer's 404 random distribution of data may reduce data latency through the system 400. The load balancer element 404 may include an application executing on a general purpose computer 50 or on any device associated with the system 400 as either software or hardware.

The system firewall 406 may provide a secure, high-speed connection to a computer network such as the Internet as illustrated in FIG. 1. The web server 402 may face the users and communicate with a number of silos 410, 412. A silo 410, 412 may be a conceptual collection of servers that work together through an application interface. Each silo 410, 412 may include an application server 414 executing a system application program 415, wherein the application server 414 may communicate between the web server 402 and a master data server 416, and the master data server 416 may communicate with replication data servers 420. A system application program 415 running on the application server 414 may perform any coordination, transformation, or update process on the data entering or exiting the master data server 416. Further, a system application program 415 may execute on any general computing device 50 in communication with the master data server 416. A system application program 415 running on the application server 414 may include, for example, any combination of an e-mail engine, a query engine, a validation engine, a crypto engine, an award engine, or a transaction engine. The replication data servers 420 may include a duplicate copy of the user profile data assigned to a silo 410, 412.

The silos 410, 412 may provide simple system expandability by providing more silos 410, 412 to the system. The silos 410, 412 may also provide specialized functions within the system 400. For example, the silos 410, 412 may include an administrative silo 412 and member silos 410. The administrative silo 412 may be used by the system 400 to manage system information, campaign information, or any other information that may not relate to the user profiles. The administrative silo 412 may also include a lookup table that may direct any data queries to the correct member silo 410. The member silos 410 may hold an equal or approximately equal fraction of the total amount of user information contained in the system 400 as determined by the load balancer 404. As illustrated in FIG. 8, a system comprising two member silos may each hold approximately 50% of the total system 400 user information. Upon registration, a user's information may be randomly stored in one member silo 410. The silo containing the user's registration data may be called the user's “home silo.” Each user's information may be kept in the user's “home silo,” and may remain in the home silo unless the member silos 410 may be rebalanced. By randomly assigning profiles to the silos 410, 412, the system load may be balanced and the number of user profiles saved to a single member silo 410 may be no more than any individual silo 410.

Further, the silos 410, 412 may collectively communicate with a backup system 422. The backup system 422 may store a duplicate copy of all data stored in the system silos 410, 412. The backup system 422 may include a very high memory capacity server including a primary backup server 424. An example of a very high memory capacity server 424 may be a 2 TB array server. The primary backup server 424 may communicate with a high capacity data cache 426. An example of a high capacity data cache may be a 21 slot, 2-drive LTO2 tape library such as the Exabyte® Ultrium™ family of LTO tape drives. The backup system 422 may further include a secondary backup server 430. The secondary backup server 430 may also be a 2 TB array server. The secondary backup server 430 may also communicate with a secondary high capacity data cache 432. An example of a secondary high capacity data cache may be an LTO3 tape drive such as the Quantum® LTO-3 drive.

The member silo 410 replication data servers 420 may collectively communicate with a data warehouse system 434. The replication data servers 420 may communicate with a database server 436. The database server 436 may include an extract/transform/load (ETL) server. The database server 436 may communicate with a data warehouse server 440. The data warehouse server 440 may include a 2 TB array. The data warehouse system 434 may also include legacy data related to prior versions of the points-awarding system 400. The legacy data may be stored in a modular workgroup server 442 such as the Sun Microsystems® E420R. The workgroup server 442 may further communicate with one or more data stores 444 containing the legacy data.

A proprietor interface system 446 may also communicate directly with the system 400 through the system firewall 406. The proprietor interface system 446 may allow a proprietor to directly access user data stored on the system silos 410, 412. This access may allow the proprietors to collect demographic and statistical information concerning the user data on the silos 410, 412. The proprietor interface system 446 may include a proprietor interface 450. The proprietor interface 450 may be a secure connection to allow the proprietors to upload or download data to the system 446. The proprietor interface 450 may employ a protocol enabling the secure transmission of web pages such as hypertext transfer protocol over a secure socket layer (https).

The proprietor interface 450 may be in communication with a file processing element 452. The file processing element 452 may allow proprietors to access the system 400 to shop for demographics information or to store and process client information or added demographics questions for use during user registration. Proprietors may also upload member activity which is stored as member transactions in the member's home silo and which may, further, trigger both billable activity transactions and award transactions in association with each particular member and each particular campaign.

An e-mail relay system 448 may also communicate with the system 400 though the firewall 406. The e-mail relay system 448 may include four servers 450, 452, 454, 456 in communication with the system 400. The e-mail relay system 448 may direct incoming e-mails, such as delayed bounces from outgoing bulk mails sent by the system, to the proper components of the system 400.

A web content staging and testing system 458 may also communicate with the system in a variety of methods. For example, the web content staging and testing system 458 may communicate with the system 400 through the web severs 402. The web content staging and testing system 458 may comprise a number of general computing devices 50 that may provide a secure and efficient environment for system 400 administrators to develop a variety of data for the system 400 before the data may be deployed live.

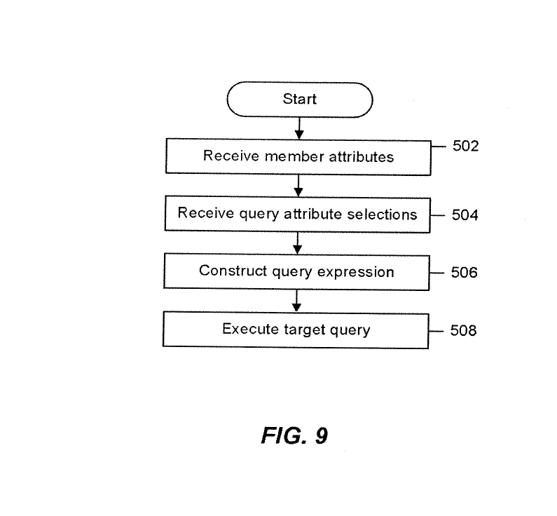

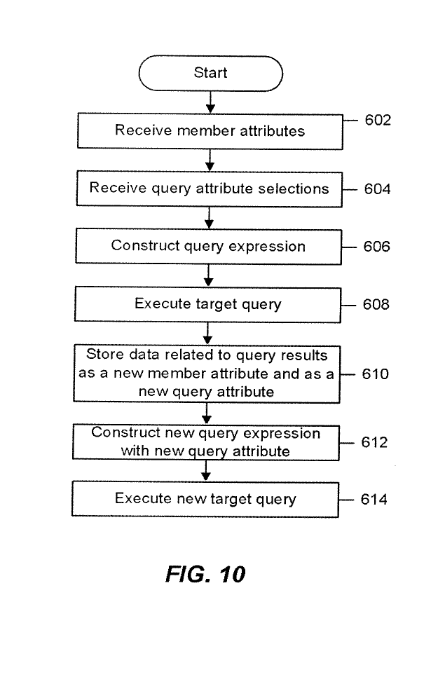

An efficient and user-friendly method of creating and executing queries targets members having desirable attributes across a number of member silos/server groups, an exemplary embodiment of which is illustrated in FIGS. 9 and 10. The methods of FIGS. 9 and 10 may be utilized in conjunction with any of the exemplary system architectures disclosed in FIGS. 1-3, 5, 7, and 8, as well as any other similar architecture. The methods are disclosed hereafter with reference to the components shown in FIG. 7, however one of ordinary skill in the art will appreciate that the methods could be implemented using the components from the embodiments disclosed in FIGS. 1-3, 5, 8, or any other similar embodiments. As an overview, members are assigned a large variety of attributes, which may be stored in each member's profile contained within a member silo 360 as member attributes. Member attributes may include a wide variety of information about the member, including, but not limited to, demographic information, member activity information, information derived from other member attributes, etc. For example, an external process may monitor past activity of a member and update the information in the corresponding member attribute. Member attributes may be described as a question and a response, where a member's choice of one or more answers to the question is stored as the response and indicates the presence or absence of a particular response in the member profile.

The target system and method allows a query user, such as an administrator, to select a subset of existing query attributes stored within the system and to use the selected query attributes to construct a query expression. Each query attribute may include one or more questions each having one or more answers. An answer of the query attribute corresponds to a member attribute that the query user desires to include or exclude when executing a query. In order to select query attributes and build a query expression, the query user may be provided with a user interface, such as a graphical user interface (GUI), that provides the various query attributes and query operators as options to the query user, and which the query user may select (e.g., via point and click, mouse, keyboard or any other manner of input) in order to build the query expression. The user interface may be executed by the administrative silo 362. Using the query expression, a query may be executed, for example by using a target query engine, across one or more of the member silos 360, where the query targets those members having one or more member attributes matching the answers from the query attributes as described in the query expression. The query may be executed by each member silo 360, and in particular may be executed by each of the member silos 360 in parallel. When executing the target query method disclosed herein, such as selecting query attributes, building a query expression and executing a query, the user interface, the administrative silo 362 and/or the member silos 360 may engage in a series of application programming interface calls to send and receive instructions related to each function of the target query method.

Referring to FIG. 9, member attributes may be received and maintained by the member silos 360 of the enterprise system 350 (block 502). As discussed above, member attributes include a wide variety of information about the user, some of which may be received by querying the member for information. For example, when a member first registers with the enterprise system 350, the member may be prompted to provide information for a member profile, such as name, address, date of birth, gender, various interests, etc. Each of the prompts, or queries, may be referred to as questions having one or more answers and the member's choice of answer(s) may be referred to as a response, where the question and response combination are stored within the member profile as a member attribute. In some instances, a member may not provide a response, in which case the question of the member attribute does not include a response. Initially, the same questions may be provided to all of the members, however, the answers to the questions may prompt subsequent questions that are not the same for all the members. For example, a member who provides a response of “male” in response to the question “gender” may be prompted with subsequent questions directed to a male demographic, whereas a member who provides a response of “female” to the question “gender” may be prompted with subsequent questions directed to a female demographic. In addition, the questions may include multiple answers. For example, a member may be prompted to provide information about sporting activities that interest the member with the question “sports,” and the member may choose a single answer such as “football” as a response, choose multiple answers such as “football,” “baseball” and “basketball” as a response or set of responses or choose no answer at all.

While some member attributes may be the result of information provided directly by the member, other member attributes may be may be derived from member activity or existing member attributes. As a simple example, the member attribute “date of birth” (e.g., question=“dob” and answer=“Jan. 1, 1970”) may be used to derive the member's age which may be stored as the member attribute “age” (e.g. question=“age” and answer=“36”) within the member's profile. As a more complex example, the member attribute “member segment” may be derived based upon the member's recent activity, such as a number of points earned, a number of e-mails read, a number of web sites visited, a number of items purchased, an amount of money spent, etc., where the answer “A Member” may refer to a very active member, the answer “B Member” may refer to a semi active member and the answer “C Member” may refer to a non-active member.

Still further, a member attribute may be provided as a combination of multiple member attributes, such as deriving new member attributes from the multiplication of compound questions. For example, a new member attribute attributable to all members within one of three age ranges and within a tri-state region, “age-range-tri-state-region”, may be derived from the multiplication of the member attribute “age range” (e.g., question=age range, answer=21-25 or 26-30 or 31-35) and the member attribute “state” (e.g. question=state, answer=IL or IN or MI), the result of which may be processed as a batch and saved as a record within a database of the enterprise system 350. It is noted that while such new member attributes may be stored within the member profiles of those members having member attributes meeting the criteria for the new member attribute, the new member attributes are not necessarily stored therein and may be stored as query expressions of the member attributes from which they are derived. As will be described further below, utilizing combinations of member attributes to create new member attributes allows complicated query expressions having many trivial combinations to be expressed as more simplified query expressions utilizing member attributes that represent combinations of several member attributes. In other words, the new member attribute provides a short-hand way of describing a more complex expression encapsulating combinations of member attributes into a single member attribute, which may be especially useful when working with commonly used combinations of member attributes. As also described further below, when conducting subsequent queries for such combinations of member attributes, a user may build query expressions from a query attribute which encapsulates the combination of query attributes for the member attributes being queried, rather than re-formulating the query expression as a combination of all of the query attributes.

Of course, it should be understood that responses may change, and the member profiles may be updated accordingly. For example, the member attribute “age range” may change as the member has a birthday, and the member attribute “state” may change if the member moves. As a result, the enterprise system 350 may execute background tasks that run slowly in the database so as not to interfere with other active processes or overwhelm the system, and which may continually compute expressions and update the system with updated member attribute information to be used by other processes or subsequent queries. Using the example above, the query expression ((“age range”=“21-25” or “26-30” or “31-35”) and (“state”=“IL” or “IN” or “MI”)) may be executed as a background task, the results of which may be used to update the member attribute “age-range-tri-state-region”. It is noted, however, that the old attribute information is not necessarily discarded, but rather may be maintained for a period of time within a separate table or data historian so as to track the history of the member. This allows the target query method to also target member attribute information on a historical basis in addition to a current basis by querying the historical table or data historian.

Accordingly, referring again to FIG. 9, the target query method continually receives member attributes, whether directly from the members, derived from other member attributes, generated through expressions of a combination of member attributes or through updates to existing member attributes (block 502). As discussed above, new member attributes can also be defined by users such as proprietors or administrators via a user-friendly interface. For example, proprietors may extend the list of attributes by entering new demographic questions and corresponding sets of answers, which will be subsequently presented to users in questionnaires. As a result, the system 350, and in particular the administrative silo 362, may maintain a set of query attributes which may be used to construct query expressions to target those members having member attributes that match the query attributes as described in the query expression. For instance, the administrative silo 362 may store a set of questions used to construct queries and a set of answers corresponding to each of the questions, as well as additional information indicative of the number and/or type of answers allowed for each question. The user interface allows the query user to select one or more query attributes, the selections of which are received by the system 350 (block 504). Using the query attributes, a query expression may be constructed using Boolean operators (e.g., “AND”, “OR”, etc.) in addition to user-intuitive expressions such as “INCLUSION”, “EXCLUSION”, etc. The operators are received by the target query method to provide conditions for the selected query attributes (block 506).

As discussed above, a member attribute may express a combination of multiple member attributes. Corresponding query attributes may be used to express a combination of multiple query attributes which correspond to the multiple member attributes. As a result, the query user may select a query attribute that represents a more complex combination of query attributes, rather than having to select each of the query attributes individually and reconstruct the query expression. For example, the query expression:
((gender=male AND marital=divorced) OR (gender=male AND marital=married)) AND (income=high OR income=moderate)
   is a nested Boolean expression, which may be complicated and non-intuitive for the average query user to formulate, especially when the query expressions may often contain even more query attributes than the above example. However, the above query expression may be simplified by using one or more query attributes that each represent combinations of query attributes, and by further including the use of “INCLUSION” and “EXCLUSION” expressions, which may be more intuitive to the query user than other operators, such as “NOT”.

As a result, canonical expressions may be constructed, where the query expression has “INCLUSION” expressions for those member attributes to be included in the query, and “EXCLUSION” expressions for those member attributes to be excluded from the query so as to exclude members that would otherwise have member attributes targeted by the inclusion expression. Each expression may be a combination of clauses, which may be combined as a Boolean expression such as:
clause 1 AND clause 2 AND . . .

Each clause may be provided in the form of a combination of query attributes, which may also be combined as a Boolean expression such as:
(query attribute A) OR (query attribute B) OR . . .

As discussed above, each query attribute is provided in the form of a question and answer, so each of the clauses may be described as:
question_{—}1=answer_{—}1 OR question_{—}2=answer_{—}2 OR . . .
   To expedite the search process, answers may be assigned unique identifiers in the system. This way, answers will inherently contain information about their corresponding questions and will therefore eliminate at least one level of searching. Answer identifiers may be stored in one of any formats known in the art, such as, for example, integer numbers.

Overall, the extended query expression may have the form of:
(A AND B AND . . . ) OR (C AND D AND . . . ) OR (E AND F AND . . . ) . . .

As can be understood, there is a multiplication of separate clauses which can become very large if there are many conditions. For example, 10 conditions in three “layers” of relationships may result in specifying 1000 different clauses. Using a query attribute to represent a combination of other query attributes, each clause may be represented by a single query attribute. For example, the clauses of the above example may each be represented as query attribute as follows:
(gender=male AND marital=divorced) may be represented by the query attribute “demog=divorced_male”;
(gender=male AND marital=married) may be represented by the query attribute “demo=married_male”; and
(income=high OR income=moderate) may be represented by the query attribute “incomerange=moderate_or_high_income.

As can be understood, there is a multiplication of separate clauses which can become very large if there are many conditions. For example, 10 conditions in three “layers” of relationships may result in specifying 1000 different clauses. Using a query attribute to represent a combination of other query attributes, each clause may be represented by a single query attribute. For example, the clauses of the above example may each be represented as query attribute as follows:
(gender=male AND marital=divorced) may be represented by the query attribute “demog=divorced_male”;
(gender=male AND marital=married) may be represented by the query attribute “demog=married_male”; and
(income=high OR income=moderate) may be represented by the query attribute “incomerange=moderate_or_high_income.

As seen above, each clause is represented as a simple expression, and the combined expression is also simple. For example, the extended expression:
(gender=male AND marital=divorced AND income=high) OR
(gender=male AND marital=divorced AND income=moderate) OR
(gender=male AND marital=married AND income=high) OR
(gender=male AND marital=married AND income=moderate)
   may become:
(demog=divorced_male AND incomerange=moderate_or_high_income) OR
(demog=married_male AND incomerange=moderate_or_high_income).

As also mentioned above, the query user may utilize “INCLUSION” and “EXCLUSION” operators in order to provide more user-intuitive expressions to the user for constructing the query expression. In order to simplify the construction and execution of the query, the query user may specify two separate clauses: the member attributes to INCLUDE, and a separate expression of the member attributes to EXCLUDE from the results generated by the INCLUDE expression. This provides a more natural, user-intuitive interface for the query user, as opposed to constructing the query expression using the “NOT” Boolean operator, for example. For example, the following query expression utilizes the “NOT” Boolean operator:
(gender=male AND marital=divorced AND income=high AND NOT shopping=books AND NOT opted_out=barnesandnoble) OR
(gender=male AND marital=divorced AND income=moderate AND NOT shopping=books AND NOT opted_out=barnesandnoble) OR
(gender=male AND marital=married AND income=high AND not shopping=books AND NOT opted_out=barnesandnoble) OR
(gender=male AND martial=married AND income=moderate AND NOT shopping=books AND NOT opted_out=barnesandnoble).
   The same query expression may be constructed in a simpler form using INCLUSION and EXCLUSION expressions, where the INCLUSION expression may be provided as:
INCLUDE (gender=male AND marital=divorced AND income=high) OR
(gender=male AND marital=divorced AND income=moderate) OR
(gender=male AND marital=married AND income=high) OR
(gender=male AND marital=married AND income=moderate)
   and the EXCLUSION expression may be provided as:
EXCLUDE (shopping=books OR opted_out=barnesandnoble).

This helps to avoid multiplicative effect, and a user may naturally read the meaning of the expressions. Referring to the above example, a user may naturally and more intuitively create and read a query expression for counting the members who are male and married or divorced and have high or moderate income but excluding the members who buy books or who have opted out of BARNES AND NOBLE emails. In particular, the above example inverts the AND and OR operators in combining the two EXCLUSION expressions, because it is less intuitive for many non-technical query users to specify:
(gender=male AND marital=divorced AND income=high AND NOT shopping=books AND NOT opted_out=barnesandnoble)
   because it involves a combination of two Boolean operators into a single operation (AND NOT), whereas in the context of an EXCLUSION expression, the more natural single operator OR can be used. The use of EXCLUSION and INCLUSION expressions further corrects for ambiguities that may result from interpreting Boolean expressions. For example, the Boolean expression “AND NOT shopping=books” may be ambiguous, in that the meaning may be to include everyone who didn't shop for books, or the meaning may be to exclude people who did shop for books? The results in each case (e.g., the resulting set of members) may be different. However, within an explicit EXCLUSION expression, the ambiguity in a natural reading of the expression may be eliminated, and in the example provided the EXCLUSION expression explicitly excludes people who did shop for books.

As a further instance of ambiguities that may result from Boolean expressions, there is a difference between including members with a member attribute versus excluding members without the same member attribute, or vice-versa. For example, the query expression:
income=high AND NOT gender=male
   does not necessarily exclude all males, because it may not be known whether a particular member is male, which may be due to a lack of a response to a question. In such a case, the member attribute recorded in the system as the absence of the member attribute, such as the absence of “gender=male”. However, the absence of “gender=male” does not mean that the member is female. If the query expression includes an explicit EXCLUSION expression, this ambiguity is eliminated:
INCLUDE “income=high” EXCLUDE “gender=male”
   which means include high income members but exclude those known to be male. It does not exclude members for whom the gender is unknown.

Although the examples of the query expressions provided above include multiple query attributes which are selected and conditioned within the query expression by the query user, it should be understood that the query expression may include a single query attribute or no query attributes.

As such, the method may provide the query user with a variety of options via the interface, such as a list of possible questions, and for each question, a list of possible answers. From the lists, the query user may choose one or more questions, and then choose one or more answers for each question, with separate expressions for including and excluding particular member attributes. Alternatively, the query user may not choose any questions or answers. In other words, the query user may not choose any query attributes, and the query expression may contain no query attributes at all. For example, in the context of the INCLUDE expression, this may be interpreted as “all members”. In the context of the EXCLUDE expression, this may be interpreted as “no members.” Thus, the non-selection of any query attribute at all for the query expression may mean “include all members and exclude none.”

Once the query expression has been constructed, the system 350 may execute a query using the query expression (block 508). Because the query expression is constructed from query attributes, which are question and answer combinations, the query is able to target those members having member attributes with answers that match those in the query attributes, as described in the query expression. For example, a query attribute “state” which targets members residing in Illinois (e.g., question=state, answer=IL) may be described in a query expression as EXCLUDE “state=IL, in which case the query will target all members that live in a state other than Illinois, because those members have a member attribute “residence” matching the query attribute “residence” as described in the query expression.

As seen above, the member attributes and the corresponding questions and answers have been described utilizing short readable expressions, which are descriptive of the query attributes and are easily understood by a user. However, the system 350 may assign a unique identification to every question and every answer in order to maintain the member attribute information and to perform the raw query internally. Again using the example above, the question “age range” may be assigned the unique identification “AG”, the answer “21-25” may be assigned “1298”, the answer “26-30” may be assigned “1299” and the answer “31-35” may be assigned “1300”. Likewise, the question “state” may be assigned the unique identification “ST”, the answer “IL” may be assigned “3456”, the answer “IN” may be assigned “3457” and the answer “MI” may be assigned “3458”. The raw query may be expressed as (AG=1298+1299+1300)*(ST=3456+3457+3458) where “+” means “or” and “*” means “and.” However, when using the target query interface, the user may be provided with the user-readable short descriptions to provide a user-friendly format for building a query expression for the query.

The answer numbers may actually map to Structured Query Language (SQL). This may be implemented using a very thin 2-column table of answer IDs and member IDs. This allows an efficient query to find all members who match particular query attributes. For example, to find all members who are within the age range of 21-25 the SQL could be:
select member_id from Answer_Member where answer_id=1298
   Efficient “OR” clauses may be constructed by self-joining the Answer_Member table and selecting multiple answers. Because the table is very thin and contains only indexed columns, the process may be very efficient, even for large tables.

The execution of the query may be conducted across all of the member silos 360 by a target query engine contained within the administrative silo 362 or within each member silo 360, and each member silo 360 may work in parallel. As disclosed in U.S. patent application Ser. No. 11/416,661 to Bohannon et al., entitled “System And Method For Evenly Distributing Data Across A Distributed Member Architecture Utilizing A Home Silo” and filed on May 2, 2006, the contents of which are expressly incorporated by reference herein, member data, such as member profiles, may be randomly distributed among the member silos 360. As a result, the distribution of the members is balanced across the member silos 360. In the event that one of the member silos 360 is inaccessible for the execution of the query (e.g., maintenance, failure, etc.), the target query method may extrapolate query results for the inaccessible member silo 360 based upon the query results from the remaining member silos 360, because the random, balanced distribution of members among all the member silos 360 provides a good probability that the results will be similar among each silo 360. This may be particularly useful when using the target query to generate a count of members satisfying the query attributes as described in the query expression.

The execution of the query generates query results which may be received by the target query method, the enterprise system 350, the administrative silo 362, one or more of the member silos 360, or any other destination which may utilize the query results. The query results may be expressed in different forms, but generally relate to data about those members having member attributes that match the answers from query attributes as described in the query expression. In one example, the query results may include a count of the members having matching member attributes. In another example, the query results may specifically identify the members having matching member attributes, and which may be used for various campaigns, such as email campaigns.

In an email campaign, certain members may be included or excluded from receiving an email based upon particular attributes. The target query method may be used to identify those members for inclusion and/or exclusion in the email campaign, and the query results may be used to provide a targeting list for the email campaign for each targeted member as expressed by a member identification number or some other identification to uniquely identify the member. The targeting list may then be uploaded to an e-mail engine, an example of which is provided in U.S. patent application Ser. No. 11/416,687 to Bohannon et al. entitled “System and Method of Efficiently Generating and Sending Bulk E-Mails” and filed on May 2, 2006, and the contents of which are expressly incorporated by reference herein. In one example, the targeting list may be distributed to all of the member silos 360, and each member silo 360 may query the list against the member identifications to identify the matching members. In addition, one or more member attributes may be added to the member profile of the targeted members to identify the member as a matching the answers of the query attributes as described in query expression. The e-mail engine may utilize this new member attribute to subsequently identify which members are recipients of the e-mail campaign.

In yet another example, the query results may be utilized to customize web pages visited by members. For example, when a targeted member makes request to a web site to view a web page, the logic of the web page may include a query to read one or more of the member attributes of the member and use those attributes to customize the display of the web page to the member. The member profile may include a personalization slot or other predefined slot containing a flag, such as a set bit or a unique identification, which may be the result of a previous query. For instance, a member targeted as a result of the query may have its member profile updated by setting a flag within the predefined slot or by including a unique identification within the predefined slot which identifies the member as a target of a web page customization, such as an advertisement. When the member visits the web page, the logic of the web page reads the bit or the unique identification and customizes the display of the web page to the member in accordance with the bit or unique identification (e.g. displaying an advertisement is part of an advertisement campaign).

In still other cases, the results from the query may be used for subsequent target queries, disclosure of which was provided above. For example, referring to FIG. 10, member attributes may be received (block 602) as described above with reference to FIG. 9, may select query attributes (block 604) which may be used to construct a query expression (block 606). As above, a query may be executed using the query expression where the query targets those members having member attributes matching the answers from the query attributes as described in the query expression (block 608). Data relating to the results from the query may be stored as a response for a new member attribute and as an answer to a new query attribute (block 610), where the question of the new query attribute represents the query expression constructed at block 606. The new query attribute may then be utilized within another query expression (block 612) and a subsequent query may be executed that utilizes the new query expression to target those members identified from the previous query in the manner described in the new query expression and in accordance with any additional query attributes contained within the query expression (block 614). Using the method shown in FIG. 10, a query user may thereby build upon the results from previous queries in constructing new query expressions and executing new queries, rather than having to construct the query expression in its entirety.

The ability for a sales representative, account executive or other sales or marketing employee to remotely demonstrate the system to a client is extremely powerful and persuasive. Using the efficient and user-friendly method of creating and executing target queries described above in relation to FIGS. 9 and 10 allows for the first time users that are not technically trained to access the system and quickly and easily execute target queries to provide real-time counts for potential campaigns. This access may even be extended to clients not directly affiliated with the enterprise owning and operating the enterprise system 350.

A method of providing self-service access to remote, non-administrative users constructing and executing a target query may begin when the enterprise system 350 receives data corresponding to a request from a remote, non-administrative user to access the system. The system may then authenticate the remote, non-administrative user and determine a security level corresponding to the non-administrative user. The remote, non-administrative users may be assigned a specific security level to ensure that their access rights to the entire system 350 are restricted appropriately. The system may then display a graphical user interface with a Target Query menu to the remote, non-administrative user. This graphical user interface may dynamically adjust according to data associated with a specific remote, non-administrative user so that only appropriate menu items available to the remote, non-administrative user are displayed.

The system may then receive member attributes as well as a number of query attribute selections. The system 350 will then automatically construct a Boolean expression using the simplified process and execute the corresponding target query across all member server groups.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of performing a target query of a database system, the database system including data relating to member attributes, the method comprising:
providing a query user with a plurality of query attributes for selection by the query user, each query attribute including a question and answer combination;
receiving selection data relating to at least one query attribute;
constructing a logical expression comprising a combination of the selection data and Boolean operators;
executing a query of the database system using the logical expression, wherein the query of the database system targets each member having one or more member attributes matching the answers as described in the logical expression; and
assigning each answer a unique identification uniquely identifying the answer within the database system, wherein executing the query comprises targeting each member having a unique identification among the one or more member attributes that matches the unique identification of an answer as described in the logical expression.

2. The method of claim 1, wherein constructing the logical expression further comprises providing the query user with a first non-Boolean operator operating on an expression comprising zero or more query attributes, wherein the first non-Boolean operator instructs a query of the database system to target members matching the expression supplied as an operand to the first non-Boolean operator.

3. The method of claim 2, wherein constructing the logical expression further comprises providing a query user with a second non-Boolean operator operating on an expression comprising zero or more query attributes, wherein the second non-Boolean operator instructs a query of the database system not to target members matching the expression supplied as an operand to the second non-Boolean operator.

4. The method of claim 3, wherein the first non-Boolean operator operates on a Boolean expression comprising a plurality of query attributes and Boolean operators.

5. The method of claim 3, wherein the second non-Boolean operator operates on a Boolean expression comprising a plurality of query attributes and Boolean operators.

6. The method of claim 1, further comprising:
receiving a query attribute comprising a question and a plurality of answers, wherein the query attribute is not provided to the query user;
storing the query attribute as a new attribute in the database system; and
providing the new attribute to the query user.

7. The method of claim 1, further comprising receiving a query result from the query, wherein the query result comprises data relating to members having one or more member attributes matching the answers as defined in the logical expression.

8. The method of claim 1, further comprising:
monitoring member activity related to each member; and
storing a result from monitoring the member activity as member attribute data within a member profile associated with the member.

9. The method of claim 1, wherein executing a query comprises executing the query across a plurality of server groups, wherein each server group comprises a plurality of servers interoperable via an application interface, the method further comprising extrapolating a query result from one of the plurality of server groups based on query results from one or more of the remaining server groups.

10. A method of performing a target query of a database system, the database system including data relating to member attributes, the method comprising:
receiving selection data relating to a first query attribute, the first query attribute including a first question and answer combination;
receiving selection data relating to a second query attribute, the second query attribute including a second question and answer combination;
constructing a logical expression comprising a combination of the first query attribute, the second query attribute, and one or more Boolean operators;
executing a query of the database system using the logical expression, wherein the query of the database system targets each member having one or more member attributes matching the answers as described in the logical expression;
receiving a query result from the query, wherein the query result comprises data relating to members having one or more member attributes matching the answers as defined in the logical expression;
storing data relating to the query as a member attribute for each of the members having one or more attributes matching the answers from the combination of the first and second query attributes.

11. The method of claim 10, wherein data relating to the query includes the logical expression used in executing the query of the database system.

12. The method of claim 10, wherein data relating to the query includes the query result.

13. The method of claim 10, wherein constructing the logical expression further comprises providing a query user with a first non-Boolean operator operating on an expression comprising zero or more query attributes, wherein the first non-Boolean operator instructs a query of the database system to target members matching the expression supplied as an operand to the first non-Boolean operator.

14. The method of claim 11, wherein constructing the logical expression further comprises providing a query user with a second non-Boolean operator operating on an expression comprising zero or more query attribute, wherein the second non-Boolean operator instructs a query of the database system not to target members matching the expression supplied as an operand to the second non-Boolean operator.

15. The method of claim 10, further comprising assigning each answer a unique identification uniquely identifying the answer within the database system, wherein executing the query comprises targeting each member having a unique identification among the one or more member attributes that matches the unique identification of an answer as described in the logical expression.

16. The method of claim 10, further comprising:
deriving a second question and answer combination from one or more results to one or more previous queries;
storing the second question and answer combination as a new member attribute.

17. The method of claim 10, further comprising:
automatically executing a periodic task comprising:
identifying the attributes wherein answers to questions have a dependency on time or on other member attributes;
identifying member profiles storing the identified attributes;
deriving a new answer for each attribute for each identified member;
updating the answer for each identified attribute in each identified member record.

18. A method of performing a target query of a database system, the database system including data relating to member attributes, the method comprising:
receiving selection data relating to a first query attribute, the first query attribute including a first question and answer combination;
receiving selection data relating to a second query attribute, the second query attribute including a second question and answer combination;
providing a query user with a non-Boolean operator operating on an expression comprising zero or more query attributes, wherein the non-Boolean operator instructs a query of the database system not to target members matching the expression supplied as an operand to the non-Boolean operator;
constructing a logical expression comprising a combination of the first query attribute, the second query attribute, one or more Boolean operators, and the non-Boolean operator;
executing a query of the database system using the logical expression, wherein the query of the database system targets each member having one or more member attributes matching the answers as described in the logical expression and wherein the query is executed across a plurality of server groups, wherein each server group comprises a plurality of servers interoperable via an application interface;
receiving a query result from the query, wherein the query result comprises data relating to members having one or more member attributes matching the answers as defined in the logical expression;
storing the logical expression as a new query attribute in a server group distinct from any of the server groups wherein the query is executed.

19. The method of claim 18, further comprising assigning each answer a unique identification uniquely identifying the answer within the database system wherein executing the query comprises targeting each member having a unique identification among the one or more member attributes that matches a unique identification of an answer as described in the logical expression.

20. The method of claim 18, wherein the method further comprises extrapolating a query result from one of the plurality of server groups based on query results from one or more of the remaining server groups.

21. A system for executing a target query comprising:
a plurality of member server groups cooperatively coupled to a network, each of the plurality of member server groups comprising a first plurality of operatively coupled servers including an application server, a master data server and a plurality of replication data servers;
each of the plurality of member server groups configured to maintain member profiles each having one or more member attributes, wherein member profiles are randomly assigned to the plurality of member server groups and balanced among the plurality of member server groups;
an administrative server group operatively coupled to the network and to the plurality of member server groups, the administrative server group comprising a second plurality of operatively coupled servers including an application server, a master data server and a plurality of replication data servers;
the administrative server group configured to provide a display interface to a query user comprising one or more options for query attributes and one or more options for Boolean operators, wherein each query attribute comprises a question and answer combination;
the administrative server group configured to construct a Boolean expression from one or more query attributes and one or more Boolean operators selected via the display interface; and
the administrative server group configured to execute a query using the constructed Boolean expression to target member profiles having one or more member attributes matching an answer from one or more query attributes as described in the Boolean expression.

22. The system of claim 21,
wherein the administrative server group is configured to provide the query attribute options to the query user as descriptive names of the query attributes; and
wherein the administrative server group is configured to utilize unique identifications to designate the query attributes when constructing the Boolean expression and executing the query, wherein the unique identifications relate to, but are different from, the descriptive names provided to the query user.

23. The system of claim 21, wherein the administrative server group is configured to extrapolate query results from each of the plurality of member server groups based upon query results from the remaining member server groups.

24. The system of claim 21,
wherein the administrative server groups is configured to store one or more results from the query;
wherein the administrative server group is configured to create a new query attribute comprising a question and answer combination using the constructed Boolean expression to create the question and the one or more results from the query to create the answer; and
wherein the administrative server group is configured to provide the new query attribute via the display interface to the query user as an option for a new query.

25. The system of claim 21,
wherein each of the member server groups is configured to store a result from the query as a new member attribute in a member profile targeted by the query; and
wherein the administrative server group is configured to execute a new query using the target member profiles having the new member attribute matching an answer from a query attribute as described in the Boolean expression.

26. The method of claim 21, wherein the administrative server group is further configured to provide a display interface to the query user providing a first non-Boolean operator operating on a logical expression comprising zero or more query attributes, wherein the first non-Boolean operator instructs a query of the database system to target members matching the expression supplied as an operand to the first non-Boolean operator.

27. The method of claim 22, wherein the administrative server group is further configured to provide a display interface to the query user providing a second non-Boolean operator operating on a logical expression comprising zero or more query attributes, wherein the second non-Boolean operator instructs a query of the database system not to target members matching the expression supplied as an operand to the second non-Boolean operator.
